(19) United States
(12) Patent Application Publication
(10) Pub. No.: US 2019/0210531 A1
(43) Pub. Date: Jul. 11, 2019

(54) FOLDABLE/COLLAPSIBLE STEP ASSEMBLY

(71) Applicant: PRABA ENGINEERING PVT LTD, Pune (IN)

(72) Inventors: Bhushan S. Wadivkar, Pune (IN); Shrikant J. Chaphekar, Pune (IN)

(73) Assignee: PRABA ENGINEERING PVT. LTD, Pune (IN)

(21) Appl. No.: 16/243,322

(22) Filed: Jan. 9, 2019

(30) Foreign Application Priority Data
Jan. 10, 2018 (IN) TEMP/E-1/248/2018

(51) Int. Cl. B60R 3/02

(52) U.S. Cl. CPC B60R 3/02

(57) ABSTRACT

Disclosed is a foldable/collapsible step assembly, the assembly. The assembly comprises a base and a plurality of steps connected to the base by pivotally mounted linkages. Further, each step of the plurality of steps is interconnected to other step by pivotally mounted linkages. Each step of the plurality of steps comprises a first part and, a second part connected to the first part by any one of a lap joint and a dovetail joint specifically, the first part and the second part comprises a groove on its connecting face with rubber beading.

### CROSS REFERENCE TO RELATED APPLICATIONS

This application claims the benefit and priority of Application No. TEMP/E-1/1248/2018-MUM filed in the Indian Patent and Trade Marks Office on Jan. 10, 2018, the disclosures of which are hereby incorporated by reference.

### FIELD OF INVENTION

The present invention relates generally to a foldable/collapsible steps are used in recreational vehicles, and more particularly light weight foldable/collapsible steps used in recreational vehicles.

### BACKGROUND OF THE INVENTION

The doorway threshold of recreational vehicles and the like is typically high above the ground. Access to these vehicles can be difficult and even unsafe, especially for older persons who often use such vehicles. A series of permanent steps attached beneath the doorway to permit easy access would be impractical, since they would decrease the effective clearance of the vehicle and extend the width or length of the vehicle.

Hence, foldable/collapsible steps are used in recreational vehicles and are fitted within the vehicle. The foldable/collapsible steps vary from one to multiple steps depends on the wheel base of vehicle. These steps can be manual or motor assisted operated with linkages. Specifically, the platform of these steps is made of sheet steel cascaded on the top with Aluminium extruded sheets. Further, aluminium sheets are used for aesthetic appearance and for protection from environment. Specifically, FIGS. 1 and 2 shows a schematic drawings of a triple step and quad step foldable/collapsible step assembly of the prior art.

Conventionally, the platforms of the steps are made of single piece as riveted or screwed to base steel. The platforms are either sheet or extruded aluminium with the thickness in the range of 2 mm. Metal extrusion is a metal forming process in which a work piece, of a certain length and cross section, is forced to flow through a die of a smaller cross sectional area, thus forming the work to the new cross section. The process begins by heating the stock material (for hot or warm extrusion). It is then loaded into the container in the press. A dummy block is placed behind it where the ram then presses on the material to push it out of the die. Afterward the extrusion is stretched in order to straighten it. If better properties are required then it may be heat treated or cold worked.

The extrusion ratio is defined as the starting cross-sectional area divided by the cross-sectional area of the final extrusion. One of the main advantages of the extrusion process is that this ratio can be very large while still producing quality parts.

Extrusion process depends on the width to thickness ratio. For the width in consideration (220 mm), the thickness is least of minimum 2 mm. This constraint of extrusion process forces the industry to use higher thickness (and higher weight) of aluminium which is not required for the purpose. Specifically, FIG. 3 shows a step design of the foldable/collapsible step assembly of the prior art.

Accordingly, there exists a need to provide a foldable/collapsible step assembly which overcomes the above-mentioned drawbacks and provides light weight steps for foldable/collapsible step assembly.

### OBJECTS OF THE INVENTION

An object of the present invention is to reduce weight of the foldable/collapsible steps used in recreational vehicles such as caravan.

### SUMMARY OF THE INVENTION

Accordingly, the present invention provides a foldable/collapsible step assembly, the assembly. The assembly comprises a base and a plurality of steps connected to the base by pivotally mounted linkages. Further, each step of the plurality of steps is interconnected to other step by pivotally mounted linkages. Each step of the plurality of steps comprises a first part and, a second part connected to the first part by any one of a lap joint and a dovetail joint specifically, the first part and the second part comprises a groove on its connecting face with rubber beading.

Typically, wherein each step of the plurality of steps is made of press formed sheet steel and top of each step is cascaded with extruded aluminium sheets

Typically, wherein the aluminum sheets are fixed to sheet steel base by any one of sliding, riveting, screwing and hot induction welding.

Typically, wherein the first part of the step has width of 125 mm and the second part has a width of 95 mm.

### BRIEF DESCRIPTION OF THE DRAWINGS

FIG. 1 shows a schematic drawings of a triple step foldable/collapsible step assembly of the prior art;

FIG. 2 shows a schematic drawing of a Quard step foldable/collapsible step assembly of the prior art;

FIG. 3 shows a step design of the foldable/collapsible step assembly of the prior art;

FIG. 4 shows a split step of the foldable/collapsible step assembly in accordance with the present invention;

FIGS. 5 and 6 shows lap joining of the split step of the foldable/collapsible step assembly of FIG. 4;

FIGS. 7 and 8 shows dovetail joining of the split step of the foldable/collapsible step assembly of FIG. 4; and

FIG. 9 shows foldable/collapsible step assembly in accordance with the present invention.

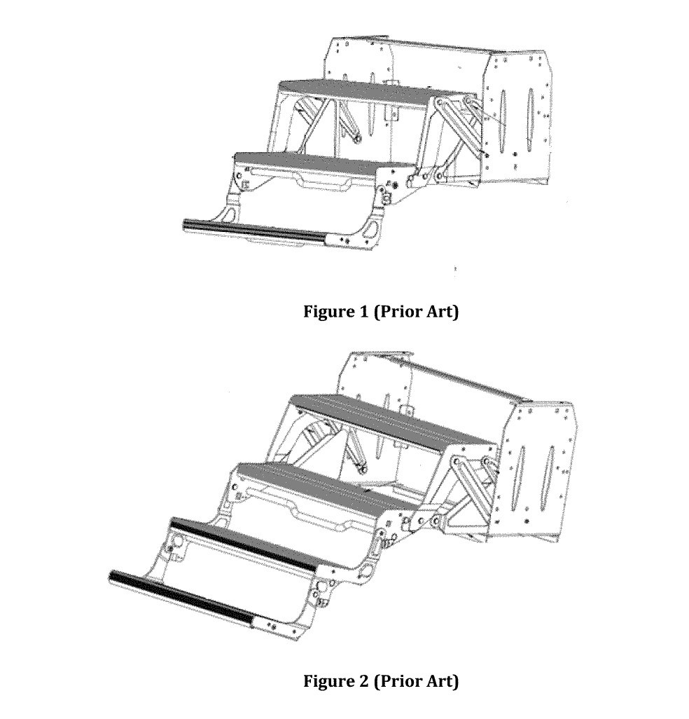

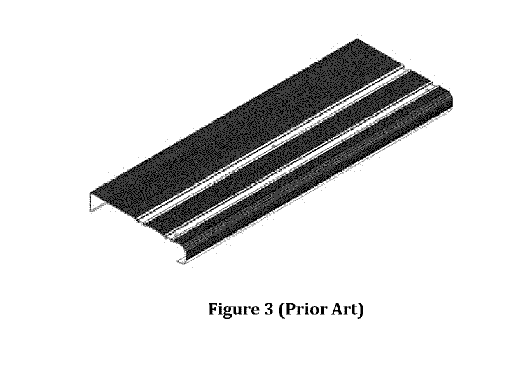

### DETAILED DESCRIPTION OF THE INVENTION

The foregoing objects of the present invention are accomplished and the problems and shortcomings associated with the prior art, techniques and approaches are overcome by the present invention as described below in the preferred embodiments.

Accordingly, the present invention provides a foldable/collapsible step assembly for use in caravan. In an embodiment, the foldable/collapsible step assembly comprises manual and motorized steps arranged within the vehicle.

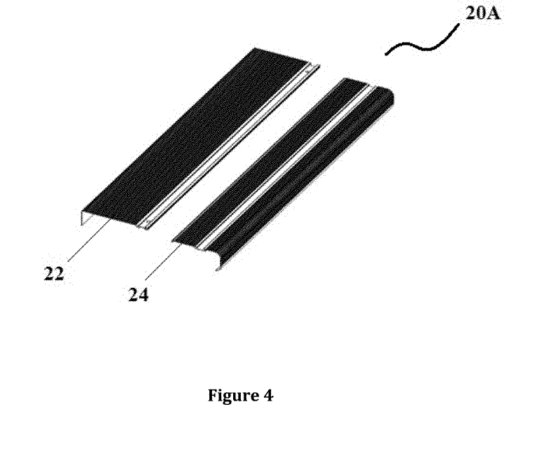

Referring now to FIGS. 4 and 8, there is shown foldable/collapsible step assembly (100) (hereinafter ‘the assembly (100)’) in accordance with the present invention. In an embodiment, the assembly (100) has a plurality of steps mounted below the door of the recreational vehicle.

The assembly (100) comprises a base (10) and a plurality of steps (20) connected to the base (10). In an embodiment, base (10) and a plurality of steps (20) are connected by the by pivotally mounted linkages (12). Further, each step of the plurality of steps (20) is interconnected to other step by pivotally mounted linkages (12).

For the purpose of explanation, each step (20A) of the plurality of steps (20) comprises a first part (22) and a second part (24). The first part (22) is connected to the second part (24) by any one of a lap joint and a dovetail joint. In an embodiment, the first part (22) and the second part (24) comprises a groove on its connecting face with rubber beading (26).

Though the step (for example (20A)) of the present invention in divided in two equal parts i.e. first part (22) and the second part (24), it is evident to those skilled in the art to make the step (20A) in two parts with unequal width.

In an embodiment, each step of the plurality of steps is made of press formed sheet steel. Further, top of each step is cascaded with extruded aluminium sheets (hereafter called as “platforms”).

In an embodiment, the aluminium sheets are fixed to sheet steel base by any one of sliding, riveting, screwing and hot induction welding.

In preferred embodiment, first part (20) of the platform has width of 125 mm and another part has a width of 95 mm. accordingly, the weight of aluminium required for making the platform of the step is reduced by minimum 50%.

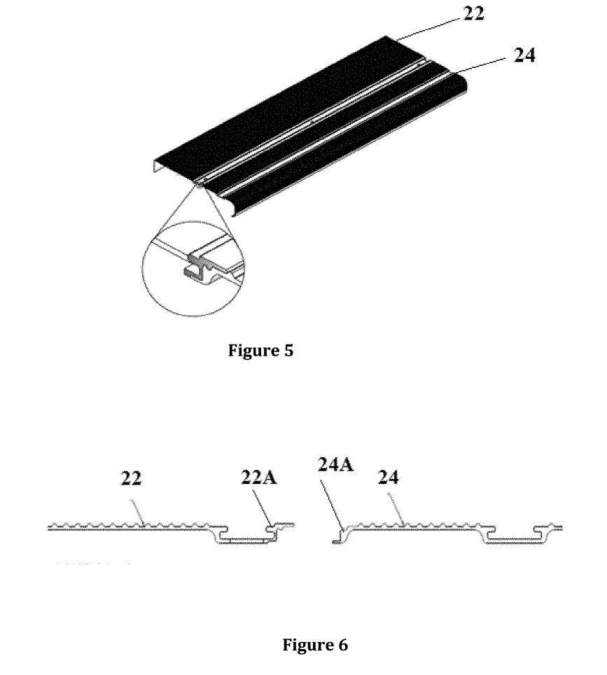

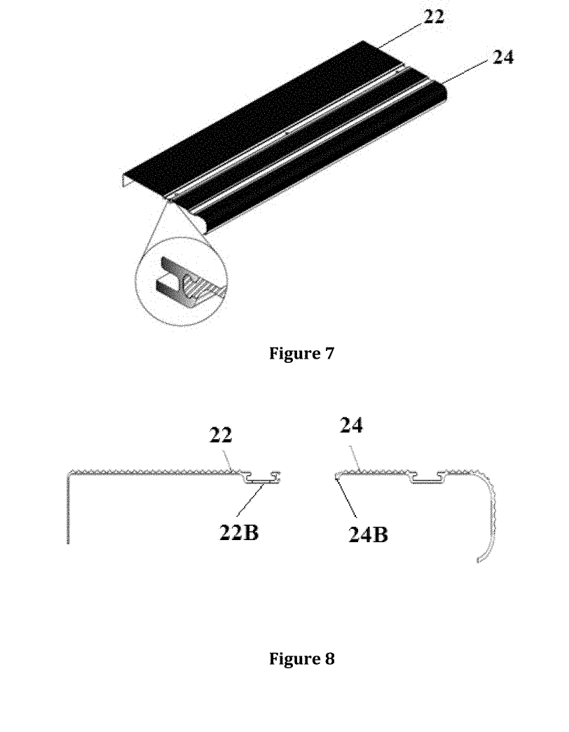

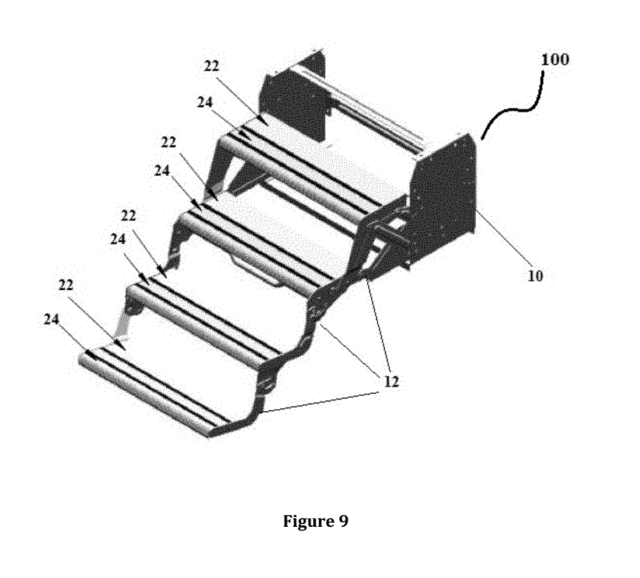

Specifically, the first part (22) and the second part (24) are connected together by anyone of lap joint as shown in FIGS. 5 and 6, and dovetail joint as shown in FIGS. 7 and 8.

In lap joint as shown in FIGS. 5 and 6, the first part (22) is made with a width of 125 mm, the overlapping portion is 8.5 mm. Specifically, the first part (22) includes a projection (22A) and the second part (24) includes a corresponding groove (24A). The second part (24) is fixed to the steel base of the first of the step assembly (20A) and the first part (22) is assembled to the second part (24) by aligning the projection (22A) of first part (22) with the groove (24A) of the second part (24). Thereafter, the first part (22) is connected to the base (10). In an embodiment, the fixation of first part (22) is done with the base (10) and then the first part (22) clamps with the second part (24).

Another embodiment of the connecting the first part (22) with the second part (24) is using dovetail joint is shown in FIGS. 7 and 8. Here, the first part (22) is made with width of 125 mm with insertion groove (22B) of 2.5 mm and the second part (24) is made with extruded portion (24B) for insertion into the insertion groove (22B). During the assembly, the first part (22) and the second part (24) are joined together with insertion and then fixed to the steel plate of the step (20A).

With the new width of the step (20A), using the two split parts i.e. first part (22) and the second part (24), the thickness of the step (20A) of the plurality of steps (20) can be reduced resulting in saving in material weight. Specifically, the present invention provides the platform of the step (20A) split into two parts, and two parts are linked together.

In referred embodiment, the first part (22) of the step (20A) has width of 125 mm and the second part has a width of 95 mm.

### ADVANTAGES OF THE INVENTION

The foldable/collapsible steps assembly (100) is light in weight as compared to the prior art.

The foldable/collapsible steps assembly (100) is easy to assemble and has increased strength.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the present invention.

What is claimed is:

1. A foldable/collapsible step assembly, the assembly comprising:
a base;
a plurality of steps connected to the base by pivotally mounted linkages, each step of the plurality of steps is interconnected to other step by pivotally mounted linkages, each step of the plurality of steps comprising:
a first part and,
a second part connected to the first part by any one of a lap joint and a dovetail joint,
wherein the first part and the second part comprise a groove on its connecting face with rubber beading.

2. The foldable/collapsible step assembly as claimed in claim 1, wherein first part comprises a projection and the second part includes a corresponding groove.

3. The foldable/collapsible step assembly as claimed in claim 1, wherein the first part comprises insertion groove and the second part is made with extruded portion for insertion in the first part.

4. The foldable/collapsible step assembly as claimed in claim 1, wherein each step of the plurality of steps is made of press formed sheet steel and top of each step is cascaded with extruded aluminium sheets

5. The foldable/collapsible step assembly as claimed in claim 1, wherein the aluminium sheets are fixed to sheet steel base by any one of sliding, riveting, screwing and hot induction welding.

6. The foldable/collapsible step assembly as claimed in claim 1, wherein the first part of the step has width of 125 mm and the second part has a width of 95 mm.
